(19) United States
(12) Patent Application Publication
(10) Pub. No.: US 2009/0301258 A1
(43) Pub. Date: Dec. 10, 2009

(54) Continously Variable Transmission

(76) Inventor: Giora Ledereich, Kiriat Tivon (IL)

Correspondence Address: YORAM TSIVION, P.O. BOX 1307, PARDES HANNA, 37111, IL

(21) Appl. No.: 10/595,843

(22) PCT Filed: Oct. 24, 2004
(86) PCT No.: PCT/IL04/00964

§ 371 Date: May 16, 2006

(30) Foreign Application Priority Data
Nov. 18, 2003 (IL) 158936

(51) Int. Cl. F16H 47/00; F16H 35/00; F16H 37/00; F16H 37/06

(52) U.S. Cl. 74/733.1; 74/640; 74/730.1; 74/661

(57) ABSTRACT

A power transmission implementing continuously variable transmission using a succession of gear sets. A first constant ratio gear-set receives torque and rotation from a motor and a second constant ratio gear set provides torque and rotation to a driven device. These two gear-sets each employ three gear elements such that the first gear-set receives power in one shaft and provides power in two shafts. The second gear set receives power in two different shafts and provides power in one shaft. Two drive chains transmit rotation and torque from the first gear-set to the second gear-set, in between the two gear sets the rotation is reversed in one drive chain. A control over the total gearing ratio of the transmission is provided by transient application of power to modify the rotation rate of one branch. In one embodiment fluid couplings are employed for transmission of power in each drive chain.

### TECHNICAL FIELD OF THE INVENTION

The present invention relates generally to transmission of torque and rotation from a motor to driven loads. More particularly, the invention is about a method of transmitting power from the motor to the driving components of vehicles such as cars, ships and locomotives.

### BACKGROUND OF THE INVENTION

Motors produce mechanical energy in rotational form, from a variety of forms of energy. Typical energies converted by motors are electric energy, hydraulic energy, internal chemical combustion, plasma streams and others. For devices utilizing power from a motor in rotational form, the functional relationship between power (work exerted by the motor per unit time), the torque (T) and rotational rate (rpm) is described in equation 1:

P=k(T×rpm) 1.

In words, the power is a function of the torque (T) exerted by the motor multiplied by the rotation rate (in rpm) of the motor.

A transmission system is required for matching between the output rotation rate characteristics of a motor, usually measured in rpm, and the requirements of the driven load. Typically, transmission systems contain one or more sets of gears, hereinafter referred to as gear-sets which transform one rotation rate into a different rotation rate as specified by physical dimension relations between elements of the gear. Usually, this relates to the ratio between the radius of engaged gears which transfer torque and rotation from one gear to another. The gearing ratio is a single numerical value that describes the transformation ratio of a specific gear-set arrangement. Usually however, a specific gear-set arrangement sustains more than one input rotation rate value, sustaining rather a range of motor velocities. The motor operates however more efficiently over a more restricted section of the sustainable range. When a desired input rotational velocity is required by a driven load, which lies outside of the permitted range of rotation rates allowed by a specific gear-set arrangement, a new gear-set arrangement is to be employed. A CVT (continuously variable transmission) differs from conventional transmission in that it can provide a continuous spectrum of gear ratios, rather then a discrete group of such ratios. A motor using CVT is able to almost always operate in its optimum rpm range, permitting more efficient motor function.

### BRIEF DESCRIPTION OF THE DRAWINGS

FIG. 1 is a general scheme describing the positioning of a transmission system of the invention;

FIG. 2 is a schematic description of the drive chain of the transmission of the invention;

FIG. 3A is a schematic layout description of a CVT of the invention showing rotation rate modifier capable of restricting rotation of a first shaft of the driving chain with respect to the frame;

FIG. 3B is a schematic layout description of a CVT of the invention showing rotation rate modifier capable of restricting rotation of a second shaft with respect to the frame;

FIG. 3C is a schematic layout description of a CVT of the invention showing rotation rate modifier capable of restricting rotation of a first and second shaft with respect to the frame;

FIG. 3D is a schematic layout description of a CVT of the invention showing rotation rate modifier capable of restricting rotation of a first and second shaft with respect to one another;

FIG. 3E is a schematic layout description of a CVT of the invention showing rotation rate modifier capable of modifying the rotation rate of a first shaft by deriving rotation from the motor shaft;

FIG. 3F is a schematic layout description of a CVT of the invention showing rotation rate modifier utilizing an external power source for inducing a rotation rate change in the branch of a driving chain;

FIG. 4A is a schematic description of a structure of a transmission system of the invention showing the direction of rotation in various sections;

FIG. 4B is a schematic description of a transmission system of the invention showing the direction of rotation in various sections;

FIG. 5 is a schematic description of the gear-sets of a transmission system of a preferred embodiment of the invention;

FIG. 6 is a schematic description of the embodiment including two parallel fluid couplers in the transmission system of the invention;

FIG. 7 is a schematic description of a transmission system of a preferred embodiment of the invention including a rotation rate adapter.

### DETAILED DESCRIPTION OF THE PRESENT INVENTION

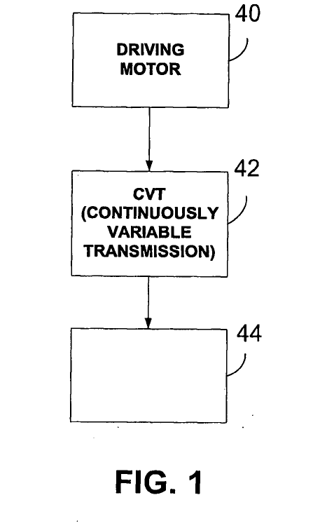

The system of the present invention is a modified power transmission which mechanically implements a continuously variable transmission (CVT). The transmission system of the invention is intended for use with motors/engines of various kinds. Schematically, this is shown in FIG. 1 to which reference is now made, a power-providing device, typically engine or motor, 40 provides the drive, in the form of torque and rotational velocity. The torque is transmitted by the continuously variable transmission system 42 of the invention and provides torque and rotation to a driven load 44. A power providing device with which the system of the invention may be compatible is any internal combustion engine, any electrical motor, any turbine, hydraulic engine and in fact any rotational power source. At the driven consumer end, the system of the invention may take the form of industrial machines, generators, road vehicles, tractors, locomotives, tanks and troop carriers, helicopters, ships and indeed any rotational mechanic machinery.

Basic Architectural Features of a Transmission of the Invention

The continuously variable transmission (CVT) of the invention employs two constant-ratio gear-sets, a first gear-set (hereinafter referred to as gear-set A) that receives torque and rotation from the power provider (hereinafter referred to a motor for all possible cases) and a second gear-set (hereinafter referred to as gear-set B) that provides torque and rotation to a consumer of rotational power. Suitable gear-sets for carrying out the tasks of gear-sets A and B of the CVT of the invention are gear-sets with three gear elements and attached shafts for inlet and outlet, such as planetary gear-sets or differential gear-sets. The basic structural and functional aspects of such gear-sets are described in chapter 17 “gear trains” of “Fundamentals of Mechanical Design” by Richard M. Phelan, second edition, McGraw Hill, New York, the contents of which are incorporated herein by reference. However any other gear-set of similar characteristics may be employed by a CVT of the invention.

Another essential component of the invention is a gear-set for reversing the direction of rotation and torque provided by gear-set A as will be elaborated below. Additional gears for adapting the rotational velocity are applied for matching the torque provided by gear-set A to the respective gear in gear-set B.

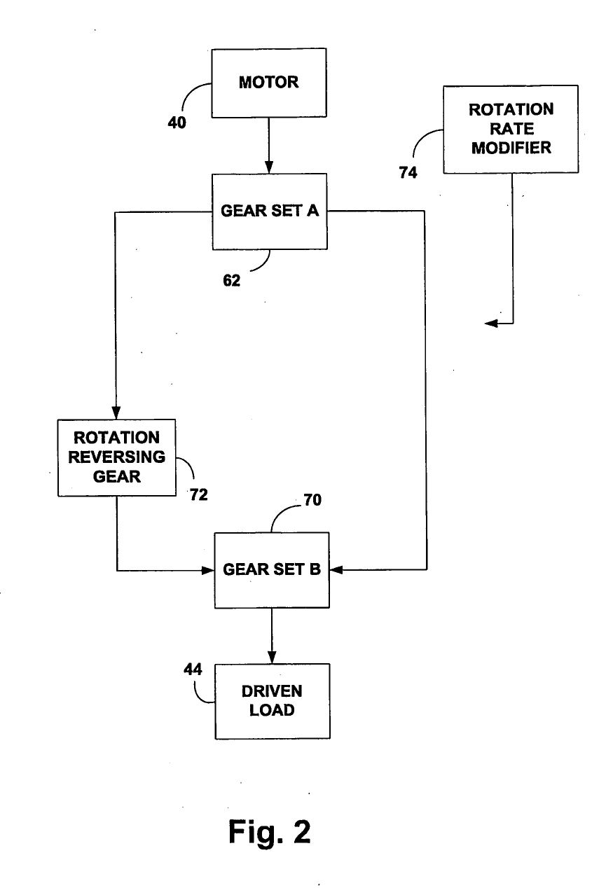

In general, the drive chain of the transmission of the present invention is partitioned into two branches, through gear-set A, such that torque and rotation are transferred in two parallel branches, to be combined again in a combining gear-set B. A scheme of the drive chain of the invention is described schematically in FIG. 2 to which reference is now made. Motor 40 provides rotation and torque to gear-set A 62 which is a torque/rotation partitioning means providing rotation and torque to one inlet gear of gear-set 70 (gear-set B), and to another inlet gear of gear-set B 70. Gear-set 72 functioning as a rotation reversing gear-set interposed between gear-set A 62 and torque/rotation combining gear-set B 70. Generally, a rotation reversing gear-set is included in the assembly of the CVT of the invention, as an independent unit, or in combination with gear-set A or B or with any other gear-set. Its position may vary within the assembly to perform its task. In some embodiments, an additional component of the invention is a rotation rate modifier 74 which exerts a rotation rate modifying effect on the rotation rate of either of the branches of the drive chain or both. In some embodiments, fluid coupling is employed as an integral part in each of the two branches the drive chain. Such embodiments will be referred to hereinafter as fluid coupled transmission systems (FCTS). In these embodiments, the fluid coupling utilizes an impeller that is connected to the motor's shaft. The impeller produces kinetic energy in the coupling fluid, which in turn actuates a turbine, also known as runner, which is connected to the driven load. The impeller and runner are both enclosed in a fluid-tight casing, in which a suitable fluid is present as well. The rotation rate of the impeller is not completely reached by the runner, and the difference between the revolution rates of the impeller and the runner is referred to as the slip of the fluid coupling. The slip in normal steady state running conditions is about 1-5% but can reach much higher.

Within the working range of the fluid coupling, the torque that can be transmitted by the fluid coupling, working under minimal slip, is characterized as follows:

a. Increases with the increase in quantity of fluid.

b. Increases with the increase in square of the rotation rate.

c. Increases with the increase in slip.

The FCTS systems of the present invention utilize these above three principles for implementing a continuously variable transmission. The fluid coupling or any other device that complies with the above three working principles may be used in the implementation of the invention.

The three inlet-outlet gears of the respective gear-set A and gear-set B of the invention comply each with the following rules: the rotation rate n in any one gear is a function of the rotation rate of the other gears, thus

1. n₁=f (n₂+n₃)

2. n₂=f(n₁+n₃)

3. n₃=f(n₂+n₁)

4. Between the torques of specific two gears of each of the above described gear-sets there exists a relationship as follows:

5. T₁=KT₂, wherein T₁ and T₂ relate to gears in the gear-set.

In words, the torque of one specific gear equals the torque of the second specific gear times a constant. The third gear is in the present invention connected to either the driving motor or the driven load.

To control the overall gearing ratio of a transmission system of the non-FCTS embodiments of the invention, the rotation rate in the two branches of the drive chain is modified by exerting a rotation rate modifying effect on at least one of the branches of the drive chain. The effect of the rotation rate modifier is exerted by either slowing down or speeding up the rotation rate of one branch of the drive chain relative to the other one. Physically, this effect takes place by the employment of a mechanical means such as a gear-set or any torque transfer mechanism, such as a belt drive, for increasing rpm or decreasing rpm. A brake system can be used for slowing down the rotation of a branch of the drive chain.

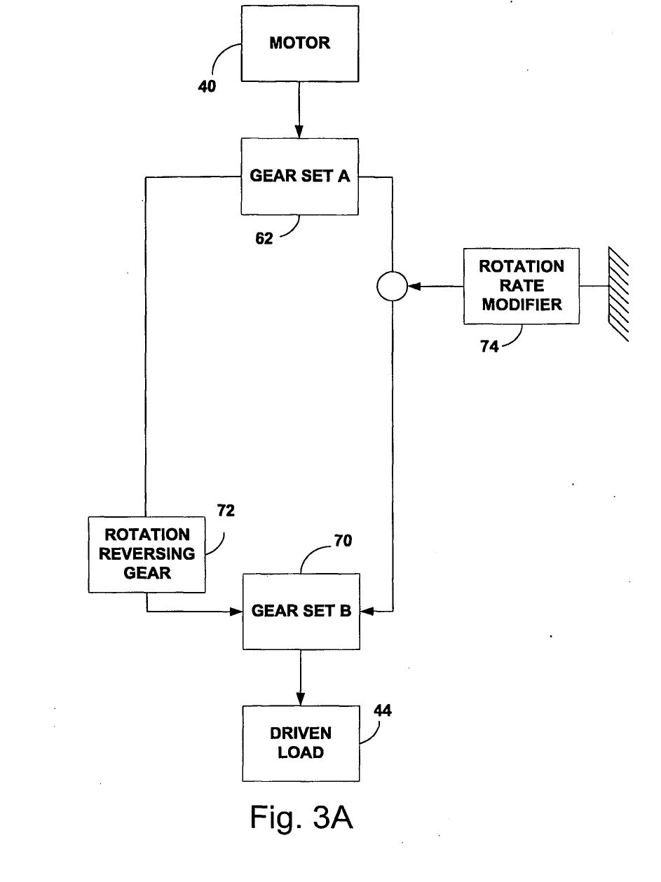

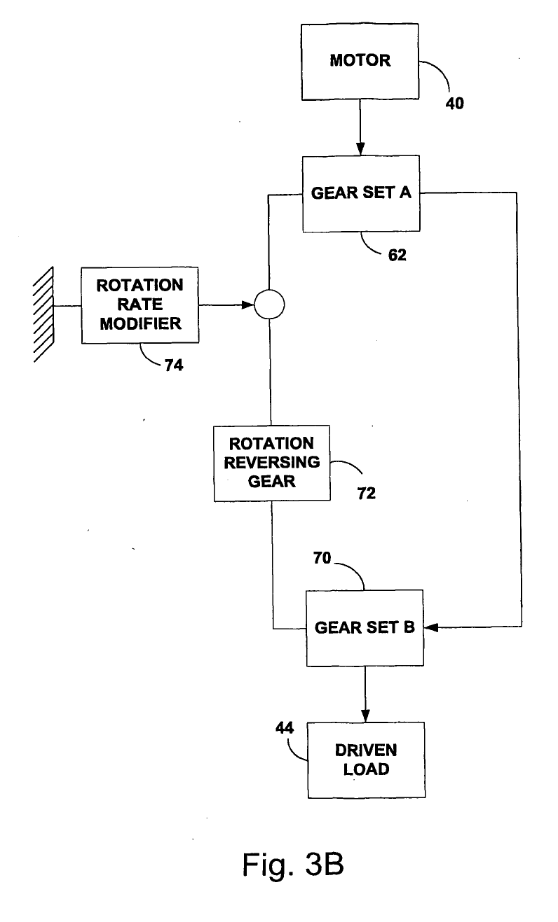

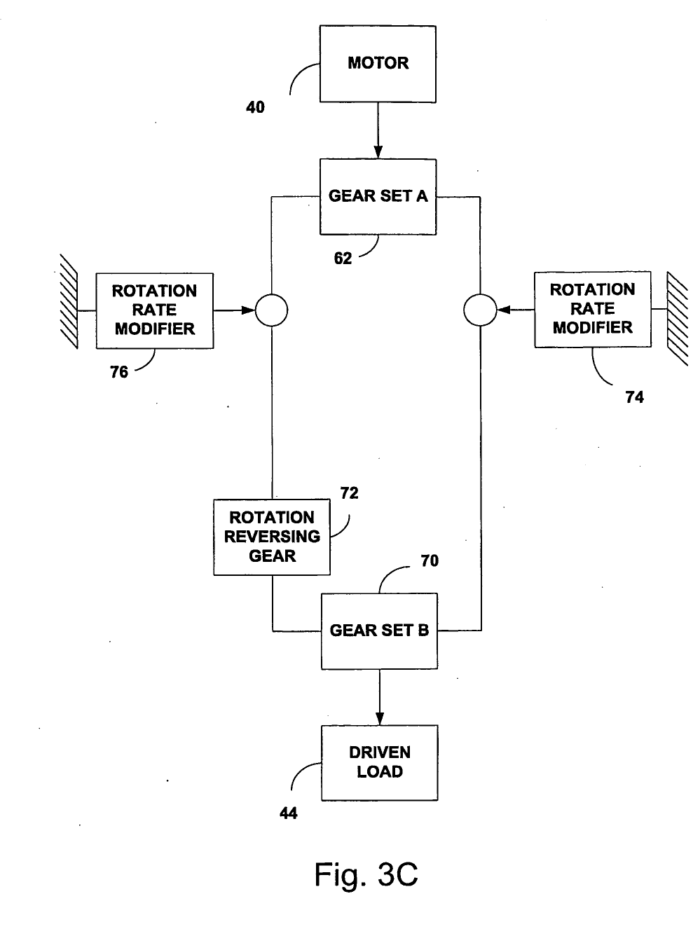

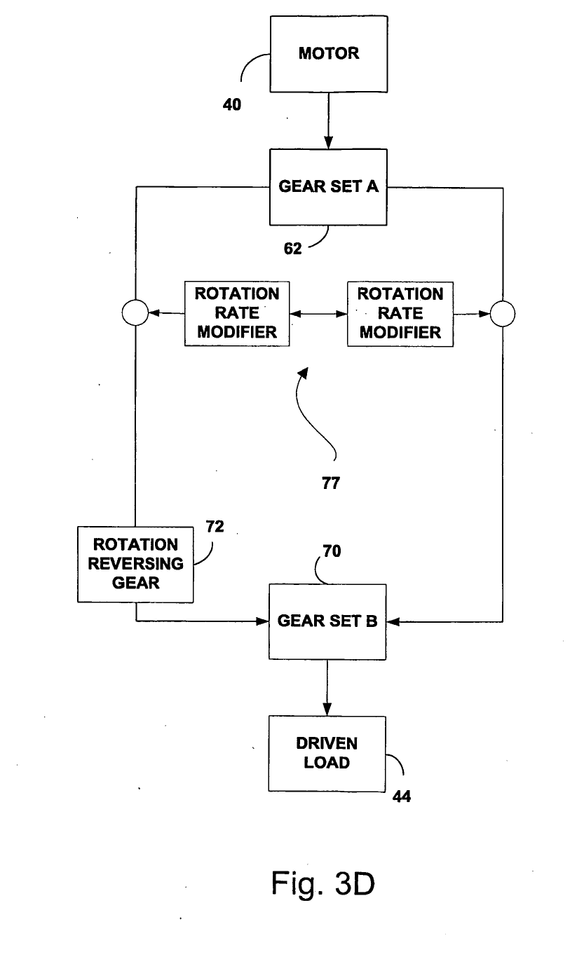

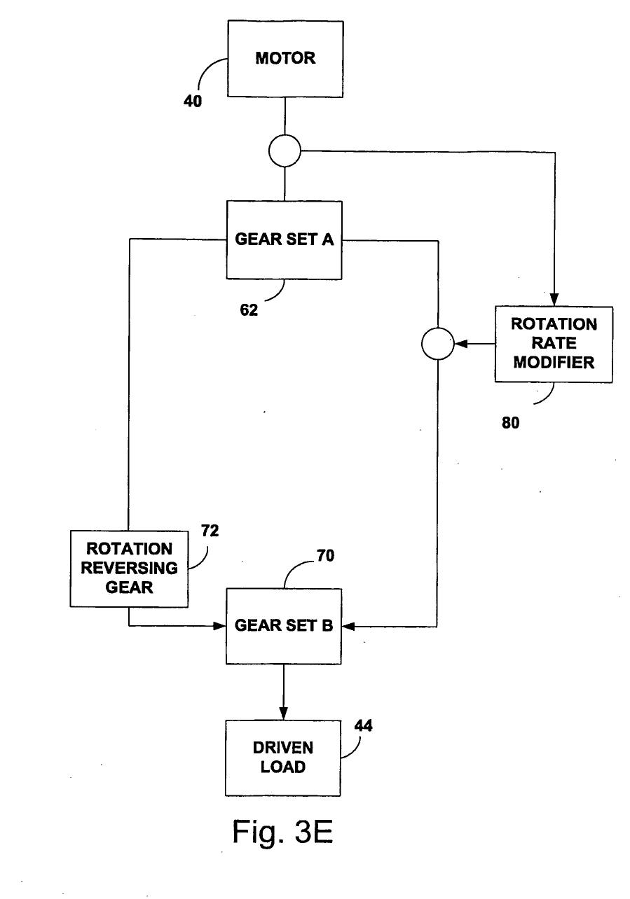

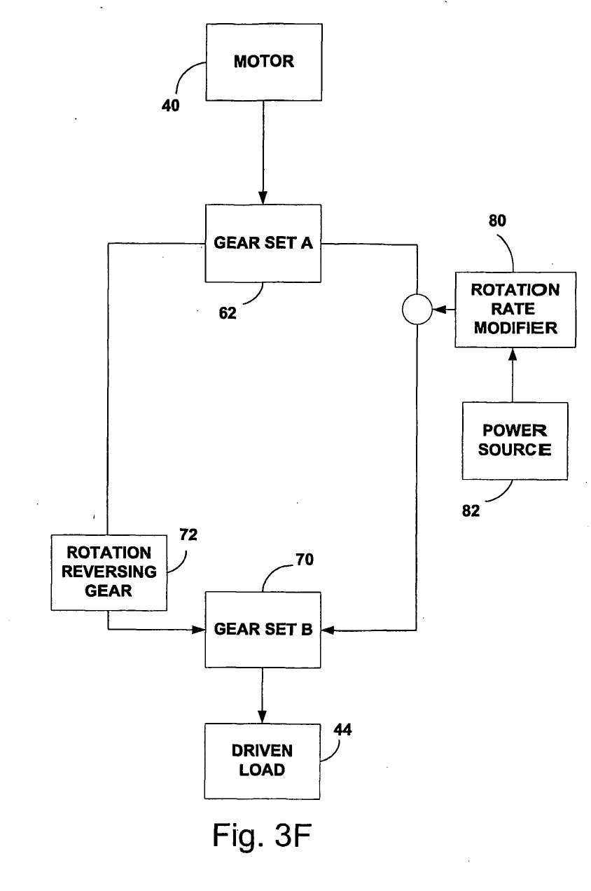

Schematic descriptions of the potential variations existing in this respect are given in FIGS. 3A-F to which reference is now made. In FIG. 3A the rotation rate modifier 74 exerts its influence on the rotation rate, typically restricting the rotation with respect to the chassis (or frame) to which the transmission is anchored. In FIG. 3B the rotation rate modifier 74 exerts its influence on the other branch of the drive chain. Alternatively, a rate modifier exerts its influence on both branches of the drive chains. This may be done as in FIG. 3C by two separate modifiers 74 and 76 or as in FIG. 3D by a complex modifier. Such a complex modifier is a secondary variably continuous transmission (VCT) gear-set as known in the art, e.g. a belt drive. If a complex modifier 77 is used, the rotation rate of one branch changes with respect to the rotation rate of the other arm, as described schematically in FIG. 3D. In FIG. 3E this is achieved by the application of a secondary VCT gear-set, transferring torque and rotation from the inlet shaft of gear-set A to a drive branch through a rotation rate modifier 80.

Generally, to achieve a rotation rate modifying effect, some mechanical means is used, such that the whole transmission system transforms from one dynamic equilibrium state to another dynamic equilibrium state. Such means may fall into any one of several classes. The modifying means involving the modifying of the rotation of one branch with respect to the frame of the transmission system. Typically this is done by frictionally restricting the rotation of a shaft transferring the torque form gear-set A to gear-set B. A more complex modifying system is a system in which the two branches are modified with respect to each other. In a third modifying type, as described in FIG. 3E above, a modifier containing a rotation transmission means such as a gear-set or a belt is used to modify the rotation of a branch is with respect to the inlet shaft of gear-set A. In yet another alternative, described schematically in FIG. 3F, a rotation rate modifier 80 uses external power source 82 to modify the rotation rate of at least one branch of the drive chain.

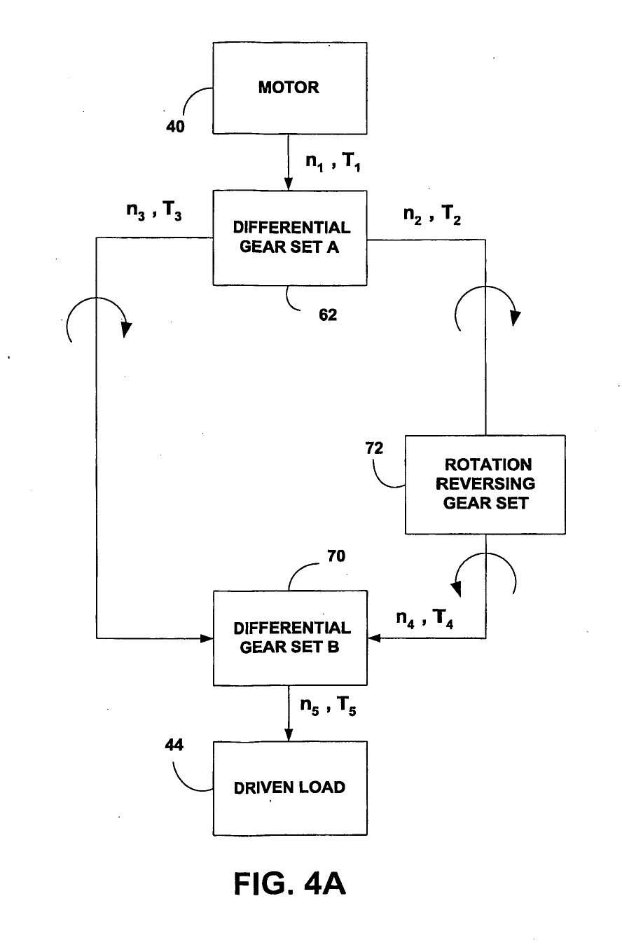

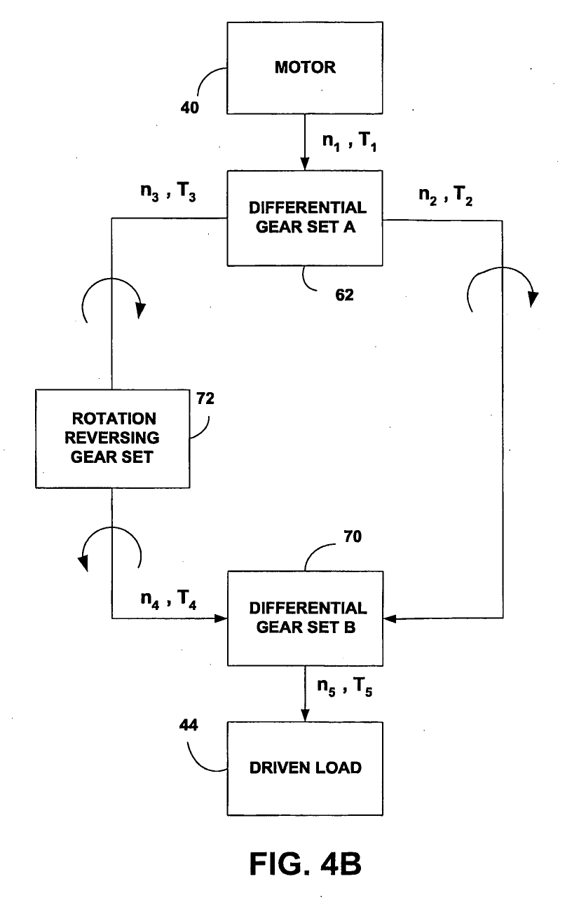

In FIGS. 4A-B to which reference is now made the rotation directions in various sections of the CVT of the invention are described. In FIG. 4A gear-set 62 and gear-set 70 are differential gear-sets. The rotation and torque are transferred from gear-set 62 to a gear-set 70 and to rotation reversing gear-set 72. The rotation rate of the gear receiving torque and rotation from the motor 40 is n₁. Further relations of rotation rates associated with the other two gears are as follows:

n₁=(n₃+n₂)/2, and

n₄=−n₂

As regards the output rotation rate,

n₅=(n₄+n₃)/2, and with respect to torque

T₃=T₂ and T₄=−T₂.

In FIG. 4B the rotation and torque are transferred from gear-set 62 to a gear-set 70 and to rotation reversing gear-set 72. The rotation rate of the gear receiving torque and rotation from the motor 40 is n₁. Further relations of rotation rates associated with the other two gears are as follows:

n₁=(n₃+n₂)/2, and

n₄=−n₃

As regards the output rotation rate,

n₅=(n₄+n₂)/2, and with respect to torque T₃=T₂ and T₄=−T₃.

Generally, a rotation reversing gear-set may be included in the assembly of the CVT of the invention, as an independent unit, or in combination with gear-set A or B or with any other gear-set. Its position may vary within the assembly to fulfill its task.

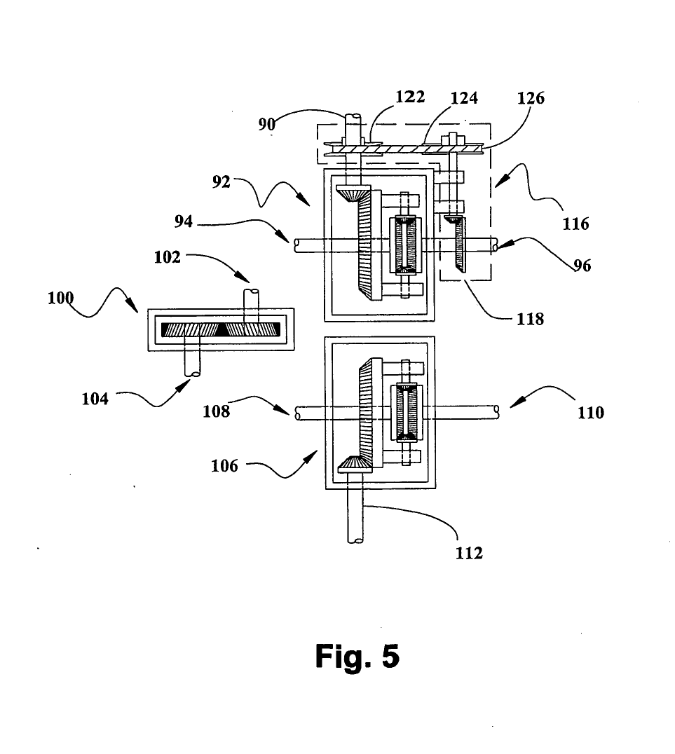

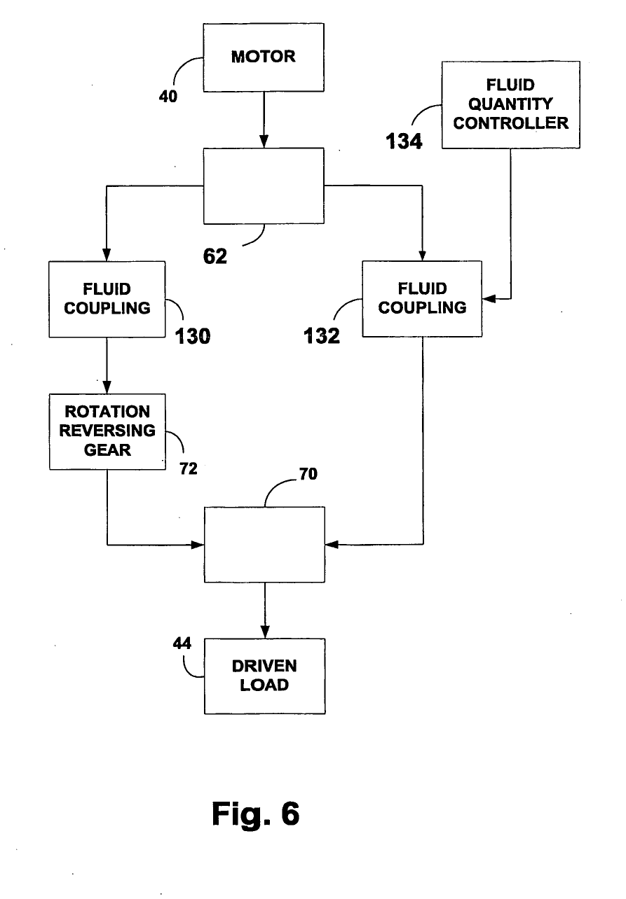

The main mechanical components of the invention pertaining to one embodiment are shown in schematic terms in FIG. 5 to which reference is now made. Inlet shaft 90 provides torque and rotation which is utilized by differential gear 92, The partitioning gear 92 provides torque and rotation through two outlets, i.e, outlet 94 and outlet 96. The torque and rotation from outlet 94 are transferred to direction reversing gear 100, receiving torque and rotation at inlet 102 and transferring onwards reversed rotation and toque at outlet 104. Combining gear 106 receives torque and rotation at inlet 108 and at inlet 110. Torque and rotation are then provided to the driven load through outlet 112. The rotation modifying module 116 defined by a broken line 118 includes a secondary CVT which includes a belt drive comprising two pulleys 122 and 124 and a belt 126, for transmitting rotation to outlet 96. In a FCTS embodiment of the invention, the assembly of the components of the invention in a FCTS embodiment is described schematically in FIG. 6 to which reference is now made. Motor 40 provides rotation and torque to gear-set A 62 which provides rotation and torque to a two fluid couplings. A first fluid coupling 130 providing rotation and torque to one inlet gear of gear-set 70 (gear-set B), and a second fluid coupling 132 providing rotation and torque to another inlet gear of gear-set B 70. Gear-set 72 functioning as a rotation reversing gear-set interposed between fluid coupling 66 and gear-set B 70. An additional component of the invention is a fluid quantity controller 134 which determines the quantity of fluid in fluid coupling 68. In the FCTS embodiments of the present invention a fluid coupling promotes the continuous gearing ratio change aspect of the CVT of the invention. The torque transmitted by a fluid coupling working under minimal slip and within the prescribed rotation rate limits is changed by three independent conditioning factors:

a. Increases with the increase in quantity of fluid.

b. Increases with the increase in square of the rotation rate.

c. Increases with the increase in slip.

In one variant of this embodiment an impeller-runner type of fluid coupling is used, the functionality of which is discussed above. To explain the function of a FCTS embodiment reference is made to the schematic description FIG. 6 Motor 40 provides rotation and torque to gear-set A 62 which provides rotation and torque to a two fluid couplings. A first fluid coupling 66 providing rotation and torque to one inlet gear of gear-set 70 (gear-set B), and a second fluid coupling 68 providing rotation and torque to another inlet gear of gear-set B 70. Gear-set 72 functioning as a rotation reversing gear-set interposed between fluid coupling 130 and gear-set B 70. An additional optional component of the invention is a fluid quantity controller 74 which determines the quantity of fluid in fluid coupling 132.

### Applying Control Over a CVT of the Invention

To change the rotation rate provided by a non FCTS CVT of the invention to the driven load, a rotation rate modifier is activated until a new state is achieved. To activate the modifier a control mechanism is applied to the modifier. Such a control mechanism may be an actuator that engages a secondary VCT gear-set that increases or decreases the rotation rate of one branch of the drive chain. Typically, when one the rotational rate of one branch is decreased, the other branch increases its rotation rate. Another control mechanism is an actuator of a brake system, that decreases the rate of revolution of one branch of the drive chain. The power for actuating the secondary gear or the brake may be of several sources, for example an external power source (FIGS. 3A, 3B, 3C, 3F), power transferred between the parts of the transmission system (FIGS. 3E, 3D).

In a FCTS embodiment, the rotation rate modifier is a fluid quantity controller. Such is described schematically in FIG. 6 to which reference is again made. Fluid coupling 132 passes rotation and torque from gear-set A 62 to gear-set B 70. The fluid quantity controller 134 can be used to determine the overall gearing ratio of the CVT of the invention, the effective quantity of fluid in at least fluid coupling 132, one of the two fluid couplings of the transmission system of the invention. Changing (either increasing or decreasing) the amount of liquid in the fluid coupling immediately results in changed rotation rate of the fluid coupling and subsequently of other parts of the CVT.

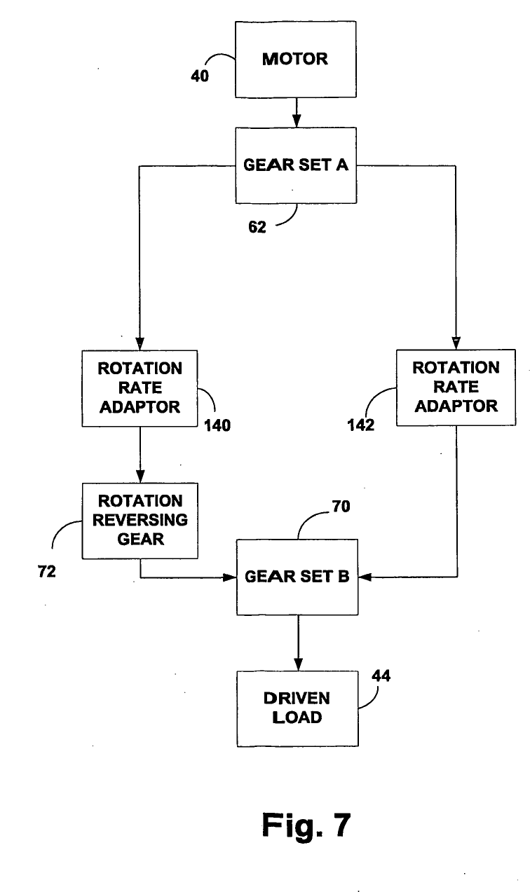

As mentioned above, one or more rotation rate adapting gear-sets may be included in the assembly of the CVT of the invention, either as a stand alone gear-set in combination with gear-set A or B or with any other gear-set. The employment of such gear-sets in a drive chain embodying the invention is described schematically in FIG. 7 to which reference is now made. Rotation rate adaptor 140 is inserted between rotation reversing gear-set 72 and between gear-set A 62. In another example shown in the same figure, the rotation rate adaptor 142 is inserted between gear-set A 62 and gear-set B 70.

### BENEFITS OF THE INVENTION

A transmission system of the inventions can accept any torque/rpm input range to produce any torque/rpm output range. In this respect the system is therefore limitless within the prescribed working boundaries. Moreover, for any torque/rpm combination provided by a motor, the system can output any other torque/rpm combination. A preferred embodiment of the invention transmits power from the motor/engine to the driven load entirely by way of shafts and gears and therefore is a very efficient transmission system.

Using the CVT of the invention can not only match an exact torque/rpm combination for any consumed power by the driven device, but as result it can keep the motor working in a maximum performance for any given motor torque or rpm required by the driven load. For combustion engines this means that optimum efficiency can be attained, by burning a minimum amount of fuel consumed per unit power used by the driven load. Further, owing to the efficient use of fuel, less pollutants are released into the atmosphere by the oxidation of fuel.

1. A continuously variable transmission system for conveying rotation and torque from a motor to a load, comprising:
a first gear-set for receiving torque and rotation from a motor and for delivering said torque and rotation in two shafts;
a second gear-set for receiving torque and rotation from said first gear-set in two shafts, and for transferring torque and rotation to said driven load;
one rotation-reversing gear-set for reversing the direction of rotation of the rotation associated with one shaft of said first gear-set, and
at least one means for modifying the rotation rate of at least one shaft of said first gear-set.

2. A continuously variable transmission system for conveying rotation and torque from a motor to a load as in claim 1, and wherein a fluid coupling is employed in each of said shafts for transferring rotation and torque from said first gear-set to said second gear-set.

3. A continuously variable transmission system for conveying rotation and torque from a motor to a load as in claim 2, and wherein a fluid quantity controller determines the quantity of fluid in said at least one fluid coupling for modifying the rotation rate in said shafts.

4. A continuously variable transmission system for conveying rotation and torque from a motor to a load as in claim 1 and wherein an additional gear-set means is disposed between said first gear-set and said second gear-set for adapting the rotation rate of said first gear-set to said second gear-set.

5. A continuously variable transmission system for conveying rotation and torque from a motor to a load as in claim 1 and wherein said means for modifying the rotation rate is applied to one outlet shaft of said first gear-set.

6. A continuously variable transmission system for conveying rotation and torque from a motor to a load as in claim 1 and wherein said means for modifying the rotation rate is applied to two outlet shafts of said first gear-set.

7. A continuously variable transmission system for conveying rotation and torque from a motor to a load as in claim 1 and wherein said load is a vehicle.

8. A continuously variable transmission system for conveying rotation and torque from a motor to a load as in claim 1 and wherein said driven load is an industrial machine.

9. A method for changing the overall gearing ratio of a power transmission system by modifying the rotation rate of different gears of a same first gear-set, and wherein two different gears of a second gear-set receive rotation and torque from said first gear-set and from a rotation reversing gear set respectively, and wherein a driven load receives torque and rotation from said second gear-set.

10. A method as in claim 9 and wherein said modification is achieved by using torque from one outlet of said first gear-set to modify the rotation rate of another outlet of said first gear-set.

11. A method as in claim 9 and wherein said modification is achieved by using torque from an inlet shaft of said first gear-set to modify the rotation rate of an outlet of said first gear-set.

12. A method as in claim 9 and wherein said rotation rate modification is carried out by frictionally reducing the rotation rate of one gear of said first gear-set with respect to a frame of said transmission system.

13. A method as in claim 9 and wherein the rotation rates of two outlet gears of said first gear-set are modified each with respect to a frame of said transmission system.

14. A method as in claim 9 and wherein said modification is achieved by using torque from an external power source to modify the rotation rate of at least one outlet of said first gear-set.

15. A method for continuously changing the rotation rate and torque provided by a power transmission system to a driven load wherein the amount of fluid in at least one of two fluid couplings, wherein said two fluid couplings receive rotation and torque from different gears of a same first gear-set, and wherein two different gears of a second gear-set receive rotation and torque from said fluid couplings, and wherein a driven load receives torque and rotation from said second gear-set, and wherein one rotation reversing gear-set is employed for reversing the direction of rotation prior to conveying the rotation to said second gear-set.

16. A method for continuously changing the overall gearing ratio of a power transmission system as in claim 15, by controlling the amount of fluid in at least one of two fluid couplings, wherein said two fluid couplings receive rotation and torque from different gears of a same first gear-set, and wherein two different gears of a second gear-set receives rotation and torque from said fluid couplings, and wherein a driven load receives torque and rotation from said second gear-set, and wherein rotation reversing is implemented before said second gear-set receives rotation and torque at one gear.
